(19) United States
(12) Patent Application Publication
(10) Pub. No.: US 2020/0227728 A1
(43) Pub. Date: Jul. 16, 2020

(54) METHODS OF MAKING HIGH PERFORMANCE ELECTRODES

(71) Applicants: GM GLOBAL TECHNOLOGY OPERATIONS LLC, Detroit, MI (US); UNIVERSITY OF KENTUCKY RESEARCH FOUNDATION, Lexington, KY (US)

(72) Inventors: Xiaosong HUANG, Novi, MI (US); Jiazhi HU, Lexington, KY (US); Yang-Tse CHENG, Lexington, KY (US)

(73) Assignees: GM GLOBAL TECHNOLOGY OPERATIONS LLC, Detroit, MI (US); UNIVERSITY OF KENTUCKY RESEARCH FOUNDATION, Lexington, KY (US)

(21) Appl. No.: 16/249,513

(22) Filed: Jan. 16, 2019

(51) Int. Cl. H01M 4/1393; H01M 4/38; H01M 4/587; H01M 4/62; H01M 4/04; H01M 4/36; H01M 10/0525; C08J 3/24; C04B 35/524; C04B 35/64

(52) U.S. Cl. CPC H01M 4/1393; C04B 2235/96; H01M 4/382; H01M 4/587; H01M 4/622; H01M 4/0471; H01M 4/364; H01M 10/0525; C08J 3/24; C04B 35/524; C04B 35/64; C04B 2235/422; C04B 2235/428; C04B 2235/40; C04B 2235/425; C04B 2235/48; H01M 4/386

(57) ABSTRACT

Methods for making an electrode, such as a negative electrode or a positive electrode, for use in an electrochemical cell, like a lithium ion battery, are provided. The method includes a cross-linking step and a carbonizing step. The cross-linking step includes cross-linking a first mixture including a polymeric binder and an electroactive material including silicon, lithium, graphite, and a combination thereof to form a cross-linked intermediate electrode. The cross-linked intermediate electrode includes the electroactive material dispersed within the polymeric binder, wherein at least a portion of the polymeric binder is cross-linked. The carbonizing step includes plasma treating the cross-linked intermediate electrode or exposing the cross-linked intermediate electrode to electromagnetic radiation.

### FIELD

The present disclosure relates to methods for making high performance electrodes for lithium ion electrochemical devices including a cross-linking step and carbonizing step to improve battery life performance as well as methods for making and using such improved electrodes.

### BACKGROUND

This section provides background information related to the present disclosure which is not necessarily prior art.

High-energy density, electrochemical cells, such as lithium ion batteries can be used in a variety of consumer products and vehicles, such as Hybrid Electric Vehicles (HEVs) and Electric Vehicles (EVs). Typical lithium ion batteries comprise a first electrode (e.g., a cathode), a second electrode of opposite polarity (e.g., an anode), an electrolyte material, and a separator. Conventional lithium ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery. For convenience, a negative electrode will be used synonymously with an anode, although as recognized by those of skill in the art, during certain phases of lithium ion cycling the anode function may be associated with the positive electrode rather than negative electrode (e.g., the negative electrode may be an anode on discharge and a cathode on charge).

In various aspects, an electrode includes an electroactive material. Negative electrodes typically comprise such an electroactive material that is capable of functioning as a lithium host material serving as a negative terminal of a lithium ion battery. Conventional negative electrodes include the electroactive lithium host material and optionally another electrically conductive material, such as carbon black particles, as well as one or more polymeric binder materials to hold the lithium host material and electrically conductive particles together.

Typical electroactive materials for forming a negative electrode (e.g., an anode) in a lithium-ion electrochemical cell include lithium-graphite intercalation compounds, lithium-silicon alloys, lithium-tin compounds, and other lithium alloys While graphite compounds are most common, recently, anode materials with high specific capacity (in comparison with conventional graphite) are of growing interest. For example, silicon has one of the highest known theoretical capacities for lithium, making it one of the most attractive alternatives to graphite as a negative electrode material for rechargeable lithium ion batteries. However, current silicon anode materials suffer from significant drawbacks. Silicon-containing materials experience large volume changes (e.g., volume expansion/contraction) during lithium insertion/extraction (e.g., intercalation and deintercalation). Thus, cracking of the negative electrode (e.g., anode), a decline of electrochemical cyclic performance and large Coulombic charge capacity loss (capacity fade), and extremely limited cycle life are often observed during cycling of conventional silicon-containing electrodes. This diminished performance can be due to the breakdown of physical contact between silicon particles and conductive fillers caused by the large volume changes in the electrode during cycling of lithium ion.

It would be desirable to develop methods for preparing high performance electrode materials, particularly comprising silicon, for use in high energy and power lithium ion batteries, which overcome the current shortcomings that prevent their widespread commercial use, especially in vehicle applications. For long term and effective use, anode materials containing silicon should be capable of minimal capacity fade and maximized charge capacity for long-term use in lithium ion batteries.

### SUMMARY

This section provides a general summary of the disclosure and is not a comprehensive disclosure of its full scope or all of its features.

In certain aspects, the present disclosure provides a method of making an electrode for an electrochemical cell. The method includes cross-linking a first mixture including a polymeric binder and an electroactive material including silicon, lithium, graphite, and a combination thereof to form a cross-linked intermediate electrode including the electroactive material dispersed within the polymeric binder, wherein at least a portion of the polymeric binder is cross-linked. The method further includes carbonizing the cross-linked intermediate electrode to form the electrode. The carbonizing includes plasma treating the cross-linked intermediate electrode, exposing the cross-linked intermediate electrode to electromagnetic radiation, or a combination thereof.

The cross-linking can include heating the first mixture to a temperature of greater than or equal to about 100° C. in the presence of an inert gas, a reactive gas, or a combination thereof.

The cross-linking can include admixing a cross-linking agent with the first mixture to form the cross-linked intermediate electrode.

The cross-linking agent includes at least one reactive group selected from the group consisting of an amino group, an isocyanate group, a carboxyl group, a hydroxyl group, an anhydride group, an epoxide group, and a combination thereof.

The polymeric binder can be selected from the group consisting of poly(ether imide) (PEI), polyacrylic acid (PAA), poly(amic acid), polysulfone (PSF), polyphenylsulfone (PPSF), polyethersulfone (PESF), polyamide, polyvinylidene fluoride (PVDF), polyacrylonitrile (PAN), a polyolefin, cellulose, derivatives of cellulose, cellulose acetate, pitch, lignin, polyalkylene oxide (PAO), polyvinylidene difluoride (PVDF), polymethylmethacrylate (PMMA), polyimide (PI), copolymers, and combinations thereof.

The plasma can originate from a gas including oxygen, air, ammonium, hydrogen, nitrogen, helium, argon, neon, and a combination thereof.

The plasma can be generated by an alternating current, a direct current, a radio wave, or a microwave radiation.

The carbonizing can include exposing the cross-linked intermediate electrode to electromagnetic radiation having a frequency between about 3 kHz and about 300 GHz.

The first mixture includes a weight ratio of electroactive material to polymeric binder of about 50:1 to about 1:10.

The electrode can include an amount of a binder phase not less than about 30% by mass of the polymeric binder present in the first mixture.

The first mixture can further include electrically conductive particles.

The electrically conductive particles are selected from the group consisting of carbon black, graphite, carbon nanotubes, carbon fibers, graphene, graphene oxide, metallic powder, a liquid metal and combinations thereof.

The method can further include one or more of: (i) admixing a solvent with the polymeric binder and the electroactive material to form the first mixture; (ii) applying the first mixture to a current collector and volatilizing the first mixture to form an untreated electrode; and (iii) pressing the untreated electrode. The solvent is selected from the group consisting of: water, methanol, acetone, ethanol, N-methyl-2-pyrrolidone (NMP), dimethylformamide (DMF), and combinations thereof.

In yet other aspects, the present disclosure provides another method of making an electrode for an electrochemical cell. The method includes admixing a polymeric binder, an electrically conductive particle, a solvent, and an electroactive material including silicon, lithium, graphite, and a combination thereof to form a first mixture, a cross-linking step, and a carbonizing step. The cross-linking step includes applying the first mixture to a current collector, volatilizing the solvent to form an untreated electrode and heating the untreated electrode to form a cross-linked intermediate electrode including the electroactive material and the electrically conductive particle dispersed within the polymeric binder, wherein at least a portion of the polymeric binder is cross-linked. Alternatively, the cross-linking step includes admixing a cross-linking agent with the first mixture, applying the first mixture to a current collector, and volatilizing the solvent to form the cross-linked intermediate electrode. The carbonizing step includes carbonizing the cross-linked intermediate electrode to form the electrode, wherein the carbonizing includes plasma treating the cross-linked intermediate electrode, exposing the cross-linked intermediate electrode to electromagnetic radiation, or a combination thereof.

The cross-linking can include heating the first mixture to a temperature of greater than or equal to about 100° C. in the presence of an inert gas, a reactive gas, or a combination thereof. The cross-linking agent can include a reactive group selected from the group consisting of an amino group, an isocyanate group, a carboxyl group, a hydroxyl group, an anhydride group, an epoxide group, and a combination thereof.

The polymeric binder can be selected from the group consisting of poly(ether imide) (PEI), polyacrylic acid (PAA), poly(amic acid), polysulfone (PSF), polyphenylsulfone (PPSF), polyethersulfone (PESF), polyamide, polyvinylidene fluoride (PVDF), polyacrylonitrile (PAN), a polyolefin, cellulose, derivatives of cellulose, cellulose acetate, pitch, lignin, polyalkylene oxide (PAO), polyvinylidene difluoride (PVDF), polymethylmethacrylate (PMMA), polyimide (PI), copolymers, and combinations thereof. The electrically conductive particles can be selected from the group consisting of carbon black, graphite, carbon nanotubes, carbon fibers, graphene, graphene oxide, metallic powder, a liquid metal, and combinations thereof. The solvent can be selected from the group consisting of water, methanol, acetone, ethanol, N-methyl-2-pyrrolidone (NMP), dimethylformamide (DMF), and combinations thereof.

The plasma can originate from a gas including oxygen, air, ammonium, hydrogen, nitrogen, helium, argon, neon, and a combination thereof, and wherein the plasma is generated by an alternating current, a direct current, a radio wave, or a microwave radiation.

The carbonizing can include exposing the cross-linked intermediate electrode to electromagnetic radiation having a frequency between about 3 kHz and about 300 GHz.

The electrode can include an amount of a binder phase not less than about 30% by mass of the polymeric binder present in the first mixture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell;

FIG. 2 provides X-ray diffraction (XRD) patterns for Finished Si/PAN Electrode 1, Cross-Linked Si/PAN Electrode 1, and Untreated Si/PAN Electrode 1.

FIG. 3 shows specific capacity of a silicon-containing electrode prepared in accordance with certain aspects of the present disclosure.

FIG. 4 shows a comparison of specific capacity of a silicon-containing electrode prepared in accordance with certain aspects of the present disclosure with an untreated electrode silicon-containing electrode and a plasma treated silicon-containing electrode.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure pertains to high-performance lithium ion electrochemical cells (e.g., lithium-ion batteries) having improved electrodes. In lithium-ion electrochemical cells or batteries, a negative electrode typically includes a lithium insertion material or an alloy host material. As discussed above, conventional electroactive materials for forming a negative electrode or anode include lithium-graphite intercalation compounds, lithium-silicon alloys, lithium-tin compounds, and other lithium alloys. While graphite compounds are most commonly used, certain anode materials with high specific capacity (in comparison with conventional graphite) are of growing interest. Silicon (Si) is an attractive alternative to graphite as an anode material for rechargeable lithium ion batteries due to its high theoretical capacity. However, a large diminished Coulombic charge capacity (capacity fade) is observed during cycling caused by the large volume change in the electrode (during lithium ion insertion or intercalation and extraction or deintercalation). In addition to capacity fade and a decline of electrochemical cyclic performance, the large volume changes (e.g., volume expansion/contraction) of silicon-containing materials during lithium insertion/extraction can result in cracking of the anode and extremely limited cycle life. These challenges, especially capacity fading for silicon-based anodes, have been a barrier to their widespread use in lithium ion batteries.

The present disclosure provides methods of making improved electrodes for an electrochemical cell, which can address the above-described challenges. The methods include a cross-linking step and a carbonizing step resulting in an electrode significant performance benefits and reduces the issues associated with capacity fade, diminished electrochemical cell performance, cracking, and short lifespan associated with conventional electrode materials.

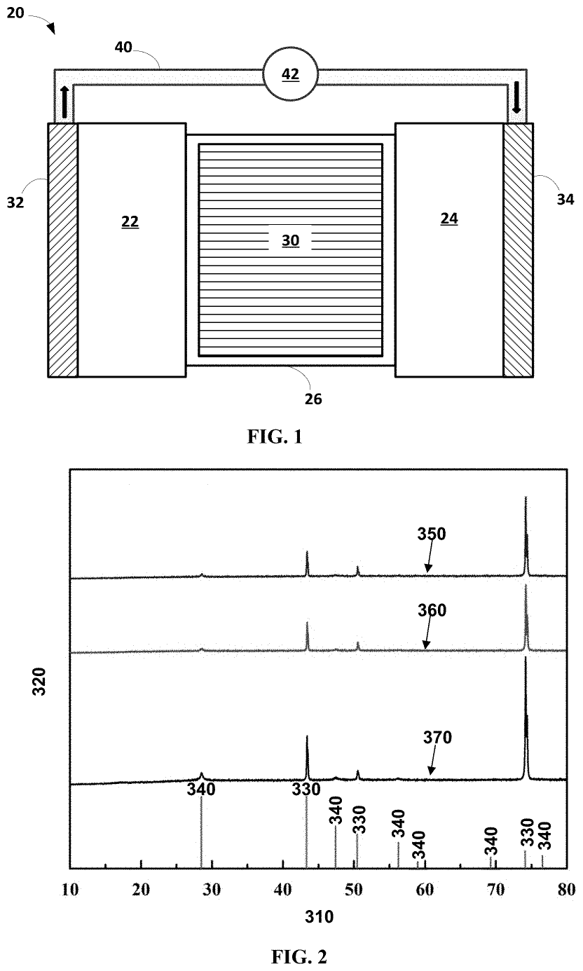

As background, electrochemical cells, especially rechargeable lithium ion batteries, may be used in vehicle or other mobile applications. An exemplary and schematic illustration of a lithium ion battery 20 is shown in FIG. 1. Lithium ion battery 20 includes a negative electrode 22, a positive electrode 24, and a separator 26 (e.g., a microporous polymeric separator) disposed between the two electrodes 22, 24. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. In alternative embodiments, a separator 26 is not included if a solid electrolyte is used. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the lithium ion battery 20.

The lithium ion battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the inserted lithium in the negative electrode 22 is depleted and the capacity of the lithium ion battery 20 is diminished.

The lithium ion battery 20 can be charged or re-powered at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with inserted lithium for consumption during the next battery discharge cycle. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator. In many lithium ion battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package.

Furthermore, the lithium ion battery 20 can include a variety of other components that while not depicted here are nonetheless known to those of skill in the art. For instance, the lithium ion battery 20 may include a casing, gaskets, terminal caps, and any other conventional components or materials that may be situated within the battery 20, including between or around the negative electrode 22, the positive electrode 24, and/or the separator 26, by way of non-limiting example. As noted above, the size and shape of the lithium ion battery 20 may vary depending on the particular application for which it is designed. Battery-powered vehicles and hand-held consumer electronic devices, for example, are two examples where the lithium ion battery 20 would most likely be designed to different size, capacity, and power-output specifications. The lithium ion battery 20 may also be connected in series or parallel with other similar lithium ion cells or batteries to produce a greater voltage output and power density if it is required by the load device 42.

Accordingly, the lithium ion battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the lithium ion battery 20 for purposes of storing energy.

Any appropriate electrolyte 30, whether in solid form or solution, capable of conducting lithium ions between the negative electrode 22 and the positive electrode 24 may be used in the lithium ion battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the lithium ion battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiAsF₆, LiCF₃SO₃, LiN(CF₃SO₂)₂, and combinations thereof. These and other similar lithium salts may be dissolved in a variety of organic solvents, including but not limited to various alkyl carbonates, such as cyclic carbonates (ethylene carbonate (EC), propylene carbonate (PC), butylene carbonate (BC)), acyclic carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

The separator 26 may comprise, in one embodiment, a microporous polymeric separator comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP.

When the separator 26 is a microporous polymeric separator, it may be a single layer or a multi-layer laminate, which may be fabricated from either a dry or wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also comprise other polymers in addition to the polyolefin such as, but not limited to, polyethylene terephthalate (PET), polyvinylidene fluoride (PVDF), and/or a polyamide. The polyolefin layer, and any other optional polymer layers, may further be included in the microporous polymer separator 26 as a fibrous layer to help provide the microporous polymer separator 26 with appropriate structural and porosity characteristics. Various conventionally available polymers and commercial products for forming the separator 26 are contemplated, as well as the many manufacturing methods that may be employed to produce such a microporous polymer separator 26.

The positive electrode 24 may be formed from a lithium-based active material that can sufficiently undergo lithium intercalation and deintercalation while functioning as the positive terminal of the lithium ion battery 20. The positive electrode 24 may also include a polymeric binder material to structurally fortify the lithium-based active material and an electrically conductive material. The positive current collector 34 may be formed from aluminum or any other appropriate electrically conductive material known to those of skill in the art.

In various aspects, the negative electrode 22 includes an electroactive material as a lithium host material capable of functioning as a negative terminal of a lithium ion battery. The negative current collector 32 may be formed from copper or any other appropriate electrically conductive material known to those of skill in the art. The negative electrode 22 can include a lithium host or negative electroactive materials and optionally, another electrically conductive material (also referred to as “electrically conductive filler material”), as well as one or more polymeric binder materials to structurally hold the lithium host material together. Such negative electroactive materials may be intermingled with the electrically conductive material and at least one polymeric binder. The polymeric binder can create a matrix retaining the negative electroactive materials and electrically conductive material in position within the electrode. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

Many lithium-ion batteries can suffer from capacity fade attributable to many factors, including the formation of passive film known as solid electrolyte interface (SEI) layer over the surface of the negative electrode (anode), which is often generated by reaction products of anode material, electrolyte reduction, and/or lithium ion reduction. The SEI layer formation plays a significant role in determining electrode behavior and properties including cycle life, irreversible capacity loss, high current efficiency, and high rate capabilities, particularly important for power battery and start-stop battery use. Additionally, as noted above, electroactive materials comprising silicon have been considered for high-performance applications (EVs/HEVs) due to their high specific capacity and energy density materials, for example, for use in anodes. In practice, however, conventional anode materials comprising silicon suffer from significant performance drawbacks. The present technology however addresses the issues found in conventional electrodes and methods of making the same and provides methods for preparing high-performance electrodes, such as silicon-containing anodes, having advantageous electrochemical performance capabilities, as well as longevity for long-term use in rechargeable lithium-ion electrochemical cells.

In conventional processes of forming electrodes, particles of electroactive materials and optional electrically conductive filler material may be mixed with a binder to form a slurry and the slurry can be cast onto a current collector. After a solid porous negative electrode is formed, it may be further imbibed with electrolyte. In accordance with various aspects of the present disclosure, methods of preparing an electrode are provided, wherein the method includes a cross-linking step and a carbonizing step to provide stabilized electrodes with advantageous electrochemical performance capabilities. As further described below in more detail, the methods described herein may be performed after a slurry comprising electroactive material and polymeric binder is cast onto a current collector or at least a portion of the methods described herein may be performed during preparation of the slurry and after the slurry is cast and dried on a current collector. It is contemplated herein that the methods described can be used to prepare a negative electrode (an anode) as well as a positive electrode (a cathode).

In various aspects, the cross-linking step may include cross-linking a first mixture comprising a polymeric binder and an electroactive material to form a cross-linked intermediate electrode. The resultant cross-linked intermediate electrode includes the electroactive material dispersed within the polymeric binder, wherein at least a portion of the polymeric binder is cross-linked.

It is contemplated herein, that the first mixture may be present in the form of a slurry comprising electroactive material and a polymeric binder prior to casting and drying (or volatilizing) the first mixture on a current collector to form an untreated electrode. Additionally or alternatively, it is understood herein that the first mixture may be present in the formed untreated electrode, for example, as an electroactive material and polymeric binder composite.

In any embodiment, the cross-linking step may comprise heating the first mixture to a suitable temperature (e.g., in an oven, in a furnace, and the like) to initiate and/or continue cross-linking of the polymeric binder, for example, above room temperature (where room temperature is about 17° C. to about 25° C.) to form a cross-linked intermediate electrode. For example, where the first mixture is present in an untreated electrode (e.g., electroactive material and polymeric binder composite), the untreated electrode can be heated to a suitable temperature as described herein to form a cross-linked intermediate electrode. It is contemplated herein, that some cross-linking of the polymeric binder may occur during drying, depending on temperature of drying, of a slurry comprising electroactive material and polymeric binder to form the untreated electrode. Based upon the polymeric binder present in the first mixture, a person of ordinary skill in the art would understand what is a suitable temperature to heat the first mixture to initiate and/or continue cross-linking of the polymeric binder. For example, the first mixture can be heated to a temperature of greater than or equal to about 50° C., greater than or equal to about 100° C., greater than or equal to about 150° C., greater than or equal to about 200° C., greater than or equal to about 250° C., greater than or equal to about 300° C., greater than or equal to about 400° C., or about 500° C.; or from about 50° C. to about 500° C., about 100° C. to about 500° C., or about 100° C. to about 400° C. Upon heating of the first mixture, substantially none of the polymeric binder may melt or at least a portion of the polymeric binder may melt. In any embodiment, the first mixture may be heated for a duration of at least about 10 seconds, at least about 30 seconds, at least about 1 minute, at least about 2 minutes, at least about 5 minutes, at least about 10 minutes, at least about 30 minutes, or about 60 minutes; or from about 10 seconds to about 60 minutes, about 30 seconds to about 60 minutes, about 1 minute to about 60 minutes, about 1 minute to about 30 minutes, about 2 minutes to about 10 minutes, or about 2 minutes to about 5 minutes. Additionally, the first mixture may be heated in the presence of an inert gas, a reactive gas, or a combination thereof. Suitable inert gases include, but are not limited to, nitrogen, argon, helium, and a combination thereof. Suitable reactive gases include, but are not limited to, oxygen, air, sulfur dioxide, hydrogen chloride gas, nitrous oxide, bromine, a mixture of bromine and oxygen, and combinations thereof. In any embodiment, when heated in the presence of a reactive gas, the reactive gas, such as oxygen, can react with the polymeric binding and participate in the cross-linking of the polymeric binder.

In any embodiment, the cross-linking step may comprise admixing a cross-linking agent with the first mixture to form the cross-linked intermediate electrode using suitable wet chemistry techniques. For example, where the first mixture is present in the form of a slurry comprising electroactive material and polymeric binder, a cross-linking agent may be admixed into the slurry. In any embodiment, admixing of the cross-linking agent can be performed at room temperature (about 17° C. to about 25° C.) and/or at a temperature above room temperature. Cross-linking of the polymeric binder can occur at room temperature (about 17° C. to about 25° C.) and/or at a temperature above room temperature. The cross-linking agent can be admixed with the first mixture before the first mixture is cast and dried onto the current collector to form a cross-linked intermediate electrode. Optionally, the cross-linked intermediate electrode may undergo further heating to continue cross-linking of the polymeric binder, for example, the cross-linked intermediate electrode may be heated to a temperature between about 50° C. to about 500° C., about 100° C. to about 500° C., or about 200° C. to about 400° C. It is contemplated herein that the polymeric binder may undergo cross-linking in the first mixture (e.g., the slurry) once the cross-linking agent is admixed and prior to casting and drying the slurry on a current collector, while the first mixture is cast and dried on the current collector, after the intermediate cross-linked electrode is formed, and combinations thereof. Suitable cross-linking agents can comprise at least one reactive group selected from the group consisting of an amino group, an isocyanate group, a carboxylic acid, carboxyl group, a hydroxyl group, an anhydride group, an epoxide group, and a combination thereof. A suitable cross-linking agent may be selected based upon the polymeric binder present in the first mixture. Non-limiting examples of suitable cross-linking agents include diglycidyl ether of bisphenol A (DGEBA), diethylenetriamine, triethylenetetramine, diproprenediamine, tetraethylenepentamine, N-aminoethylpiperazine, phthalic anhydride, pyromellitic anhydride, tetrahydrophthalicanhydride, and the like.

Following formation of the cross-linked intermediate electrode, a carbonizing step may be performed on the cross-linked intermediate electrode to produce a finished electrode (i.e., positive electrode or negative electrode) As used herein the terms “carbonize,” “carbonizing” or “carbonization” refers to a treatment, for example, plasma treatment and/or electromagnetic irradiation, of the cross-linked intermediate electrode wherein at least a portion of the polymeric binder is converted to carbon and at least a portion of the noncarbon elements of the polymeric binder (e.g., N, S, F, etc.) are removed, for example, in the form of volatile gases. Thus, the resultant electrode (finished electrode) comprises the electroactive material and a binder phase derived from carbonizing the cross-linked polymeric binder. The binder phase in the resultant electrode may have a higher carbon content (based on binder phase mass) compared to carbon content of the polymeric binder in intermediated cross-linked electrode (based on polymeric binder mass). Advantageously, the resultant electrode comprises an amount of the binder phase not substantially less than the amount of polymeric binder present in the first mixture. For example, the resultant electrode comprises an amount of the binder phase not less than about 30% (e.g., not less than about 40%, not less than about 50%, not less than about 60%, not less than about 70%, not less than about 80%, or not less than about 90%) by mass an amount of the polymeric binder present in the first mixture. In other words, if the first mixture comprises 60 mg polymeric binder and the resultant electrode comprises an amount of binder phase not less than about 30% by mass of the polymeric binder in the first mixture, the resultant electrode comprises a binder phase not less than 18 mg.

In various aspects, carbonizing the cross-linked intermediate electrode can comprise plasma treating the cross-linked intermediate electrode, exposing the cross-linked intermediate electrode to electromagnetic radiation, or a combination thereof. It is contemplated herein, that a slurry comprising electroactive material and polymeric binder (e.g., a first mixture) can undergo cross-linking as described above, for example, by admixing a cross-linking agent, to form a cross-linked slurry. This cross-linked slurry could then be carbonized by plasma treating the cross-linked slurry, exposing the cross-linked slurry to electromagnetic radiation or a combination thereof. As used herein, the term “plasma” is used to identify gaseous complexes which may comprise electrons, positive or negative ions, gaseous atoms and molecules in the ground state or any higher state of excitation including light quanta. In some embodiments, the plasma treatment is considered a low pressure “cold” plasma and generally comprises gas atoms at room temperature and electrons at much higher temperatures. This plasma state can provide an ambient gas temperature along with electrons which have sufficient kinetic energy to cause the cleavage of chemical bonds.

In any embodiment, the plasma may be initiated at any time during the carbonization by an electrical discharge through a gas or an induced dielectric breakdown through a gas and will depend primarily upon the processing system utilized. In any embodiment, the plasma may originate from a gas comprising nitrogen, helium, argon, neon, oxygen, air, ammonium, hydrogen, and combinations thereof. The generation of the plasma can be initiated by a microwave (e.g., microwave radiation), an alternating current, direct current or radio frequency (radio wave) discharge, but may also be initiated and sustained by any plasma sustaining energy commonly known in the art. The plasma may be generated at any suitable power and pressure for a suitable duration based upon the equipment used and polymeric binder present as understood in the art. For example, the plasma may be generated (e.g., by microwave radiation) at a power of at least about 200 W, at least about 300 W, at least about 400 W, at least about 500 W, at least about 600 W or about 700 W; or from about 200 W to about 700 W, about 200 W to about 500 W, or about 200 W to about 400 W. Additionally or alternatively, the plasma may be generated (e.g., by microwave radiation) at a pressure of at least about 2 Torr, at least about 4 Torr, at least about 6 Torr, at least about 8 Torr, at least about 10 Torr, at least about 15 Torr or about 20 Torr; or from about 2 Torr to about 20 Torr, about 2 Torr to about 20 Torr or about 4 Torr to about 15 Torr. Additionally or alternatively, the plasma may be generated (e.g., by microwave radiation) for a duration of at least about 2 minutes, at least about 4 minutes, at least about 6 minutes, at least about 8 minutes, at least about 10 minutes, at least about 15 minutes or about 20 minutes; or from about 2 to about 20 minutes, about 2 minutes to 15 minutes, or about 4 minutes to about 10 minutes. For example, the plasma may be generated by microwave radiation at a power of at least about 200 W and a pressure of at least about 4 Torr,

In any embodiment, the plasma utilized in the carbonizing step can be generated and maintained in a controlled oxygen free plasma chamber having the capacity to control the introduction of inert gases or the removal of off-gases from the chamber so as to allow control of the internal pressures induced by the carbonization process. The plasma can also be applied by an external source e.g., plasma plume or torch. The inert gases utilized in the present invention may include any oxygen-free gas capable of maintaining a plasma reaction and serving as a carrier for the effluents generated by the carbonization system. Examples of such gases include, without limitation, argon, nitrogen, helium, hydrogen, or any mixture thereof.

In various aspects, the electromagnetic radiation can be produced by an electromagnetic generator capable of producing an electromagnetic discharge in the electromagnetic frequency range and at power levels sufficient to carbonize cross-linked mixture. The irradiation by electromagnetic discharges can be performed using electromagnetic radiation whose frequency is between about 3 kHz and about 300 GHz or between about 0.5 GHz and about 300 GHz. The power input by the electromagnetic radiation can be between about 250 W and about 100 kW, particularly, between about 500 W and about 15 kW.

Although the description above and the examples below discuss cross-linking step using a single oven, the plasma treatment using a single plasma chamber, and a single source of electromagnetic radiation, it is anticipated that a series of ovens, a series of plasma chambers, and/or a series of electromagnetic generators may be utilized to practice the disclosed method in either a batch or continuous process. These processes may include, without limitation, a continuous flow process similar to a kiln type application with no physical separation between stages in processing, or a continual sequence process having discrete processing stages.

As discussed above, the methods described herein can be utilized for preparing positive electrodes and negative electrodes. The electroactive material can comprise silicon, lithium, graphite, and combinations thereof. For example, when forming a positive electrode, the electroactive material may comprise layered lithium transitional metal oxides. For example, in certain embodiments, the electroactive material may comprising a transition metal like lithium manganese oxide (Li₍₁₊ₓ₎Mn₍₂₋ₓ₎O₄), where 0≤x≤1, where x is typically less than 0.15, lithium manganese oxide (LiMn₂O₄), lithium manganese nickel oxide (LiMn₍₂₋ₓ₎NiₓO₄), where 0≤x≤1 (e.g., LiMn_{1.5}Ni_{0.5}O₄), lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiNi_{1/3}Mn_{1/3}Co_{1/3}O₂, LiMn_{0.5}Ni_{0.3}Co_{0.2}O₂, LiMn_{0.6}Ni_{0.2}Co_{0.2}O₂, LiMn_{0.8}Ni_{0.1}Co_{0.1}O₂, lithium nickel cobalt metal oxide (LiNi_{(1-x-y)}CoₓM_{y}O₂), where 0<x<1, y<1, and M may be Al, Mn, or the like, lithium titanate (Li₂TiO₃), other known lithium-transition metal oxides or mixed oxides lithium iron phosphates, or a lithium iron polyanion oxide such as lithium iron phosphate (LiFePO₄) or lithium iron fluorophosphate (Li₂FePO₄F).

When forming a negative electrode, the electroactive material may comprise silicon. Such a material may be silicon, silicon oxides, and silicon containing binary and ternary alloys, such as Si—Sn, SiSnFe, SiSnAl, SiFeCo, and the like. In certain embodiments, the silicon containing material comprises or consists essentially of silicon (rather than an alloy of silicon) in either crystalline or amorphous structures.

The electroactive material comprising silicon may have a round geometry or an axial geometry and thus may be in the form of particles or in alternative variations, may be in the form of thin film, nanowires, nanorods, nanosprings, or hollow tubes. The silicon structures may be nanosized or micronsized. Such silicon structures can help accommodate the large volume changes that silicon undergoes during lithium cycling in a lithium ion battery. The term “axial geometry” refers to particles generally having a rod, fibrous, or otherwise cylindrical shape having an evident long or elongated axis. Generally, an aspect ratio (AR) for cylindrical shapes (e.g., a fiber or rod) is defined as AR=L/D where L is the length of the longest axis and D is the diameter of the cylinder or fiber. Exemplary axial-geometry silicon-containing particles suitable for use in the present disclosure may have high aspect ratios, ranging from about 10 to about 5,000, for example. In certain variations, the silicon-containing particles having an axial-geometry include fibers, wires, flakes, whiskers, filaments, tubes, rods, and the like.

The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes. For generally round geometry silicon-containing particles, an average particle size diameter of a suitable silicon-containing particle may be greater than or equal to about 20 nm to less than or equal to about 100 μm, optionally greater than or equal to about 50 nm to less than or equal to about 20 μm, optionally greater than or equal to about 100 nm to less than or equal to about 10 μm, by way of non-limiting example.

In various aspects, the polymeric binder may be any suitable binder for use in a positive electrode, a negative electrode, and a combination thereof. Examples of a suitable polymeric binder, include, but are not limited to, poly(ether imide) (PEI), polyacrylic acid (PAA), poly(amic acid), polysulfone (PSF), polyphenylsulfone (PPSF), polyethersulfone (PESF), polyamide, polyvinylidene fluoride (PVDF), polyacrylonitrile (PAN), a polyolefin, cellulose, derivatives of cellulose (carboxymethoxyl cellulose (CMC)), cellulose acetate, pitch, lignin, polyalkylene oxide (PAO) (e.g., polyethyleneoxide (PEO) or polypropylene oxide (PPO), etc.), polyvinylidene difluoride (PVDF), polymethylmethacrylate (PMMA), polyimide (PI), polyvinylidene fluoride (PVDF), ethylene propylene diene monomer (EPDM) rubber, copolymers, and combinations thereof. In certain aspects, the polymeric binder is a gel electrolyte selected from the group consisting of: polyacrylonitrile (PAN), polyvinylidene difluoride (PVDF), polymethylmethacrylate (PMMA), polyalkylene oxide (PAO), such as polyethyleneoxide (PEO) or polypropylene oxide (PPO), copolymers, and combinations thereof. As used herein, the term “polymeric binder” includes polymer precursors used to form the polymeric binder, for example, monomers or monomer systems that can form the any one of the polymeric binders disclosed above.

In any embodiment, the first mixture may comprise a weight ratio of electroactive material (e.g., silicon) to polymeric binder (e.g., PAN) of about 50:1 to about 1:10, for example, about 25:1, about 10:1, about 5:1 about 2:1, about 1:1, about 2:3, about 3:2, or about 1:2. In some embodiments, electroactive material may be present in the first mixture in an amount, based on total weight of the first mixture, of about 50 wt % to about 98 wt %, about 50 wt % to about 90 wt %, or about 70 wt % to about 90 wt %. Additionally or alternatively, the polymeric binder may be present in the first mixture in an amount, based on total weight of the first mixture, of about 2 wt % to about 25 wt %, about 10 wt % to about 25 wt %, or about 5 wt % to about 15 wt %.

In any embodiment, the first mixture may optionally include electrically conductive particles (also known as conductive filler material). Suitable electrically conductive particles are well known to those of skill in the art and include, but are not limited to, carbon black, graphite, carbon nanotubes, carbon fibers, graphene, graphene oxide, metallic powder (e.g., copper, nickel, steel), liquid metals (e.g., Ga, GaInSn), and combinations thereof. Such electrically conductive particles may have a round geometry or an axial geometry as described above. Such electrically conductive particles can be admixed with the polymeric binder and the electroactive material, so that the electrically conductive particles are distributed throughout the electrode matrix. Notably, the electrically conductive particles do not typically participate in any reaction, but rather are dispersed in the polymeric binder matrix as in a typical composite. Preferably, the electrically conductive particles and electroactive material are well mixed into the polymeric binder for even distribution (e.g., homogeneous distribution) and therefore even electrical conductivity.

The first mixture of polymeric binder, electroactive material, and optional electrically conductive particles can be blended or mixed by equipment known in the art, such as for example, magnetic stirrers, mixers, kneaders, and the like. In some embodiments, a solvent or one or more vehicles may be admixed with the polymeric binder, electroactive material, and optional electrically conductive particles in the first mixture. The handling and flowability of a mixture of polymeric binder, electroactive material, and optional electrically conductive particles is dependent on the polymer or polymer precursor selected, the viscosity of the solvent/carriers, as well as a rate of crosslinking. Non-limiting examples of suitable solvents include water, methanol, acetone, ethanol, N-methyl-2-pyrrolidone (NMP), dimethylformamide (DMF), and combinations thereof. The first mixture may be applied to a current collector and volatilized to form an untreated electrode. Optionally, the untreated electrode may be pressed or calendered to reduce the porosity of the untreated electrode. In some embodiments, the finished electrode optionally may be calendered. Depending on pore size, suitable porosities may range from greater than or equal to about 20% to less than or equal to about 80% porosity for an electrode (prior to being imbibed with any electrolyte).

In further aspects, a method of making an electrode for an electrochemical cell is provided herein. The method includes admixing a polymeric binder as described herein, an electrically conductive particle as described herein, a solvent as described herein, and an electroactive material as described herein (e.g., comprising silicon, lithium, graphite, and combinations thereof) to form a first mixture. The method may further include a cross-linking step as described herein and a carbonizing step as described herein to form the electrode. The cross-linking step can include applying the first mixture to a current collector, volatilizing the solvent to form an untreated electrode and heating the untreated electrode as described herein to form a cross-linked intermediate electrode comprising the electroactive material and the electrically conductive particle dispersed within the polymeric binder, wherein at least a portion of the polymeric binder is cross-linked. Alternatively, the cross-linking step can include admixing a cross-linking agent as described herein with the first mixture, applying the first mixture to a current collector, and volatilizing the solvent to form the cross-linked intermediate electrode. The carbonizing step includes plasma treating the cross-linked intermediate electrode as described herein and/or exposing the cross-linked intermediate electrode to electromagnetic radiation as described herein.

In various aspects, an electrode (cathode or anode) prepared by the methods described herein is also provided. A concentration of electroactive material in the electrode may optionally range from greater than or equal to about 20 mass % to less than or equal to about 98 mass % of the total mass of the electrode. As appreciated by those of skill in the art, the concentration of electroactive material (e.g., silicon-containing electroactive material) required varies depending on particle size and the like. For electroactive particles (e.g., silicon-containing particles) that are nanoparticles (having an average particle size of less than or equal to about 1 μm), an amount of such nanoparticles may range from about greater than or equal to about 20 mass % to less than or equal to about 90 mass % of the total mass of the electrode. For electroactive particles (e.g., silicon-containing particles) that are microparticles, a concentration may range from greater than or equal to about 50 mass % to less than or equal to about 98 mass % of the total mass of the electrode.

A concentration of electrically conductive particles in the electrode may be correlated to a percolation threshold, which varies with particle size, particle resistivity or conductivity, and geometry or particle shape, as recognized by those of skill in the art. In certain variations, a concentration of electrically conductive particles in the electrode can range from greater than or equal to about 5 mass % to less than or equal to about 30 mass % of the total mass of the electrode.

An amount of polymeric binder in the electrode may range from greater than or equal to about 2 mass % to less than or equal to about 50 mass % of the total mass of the electrode. Generally, the smaller the particle size of the electroactive material (e.g., silicon-containing particles) and/or electrically conductive particles, the greater the amount of polymeric binder that is used.

Advantageously, the combination of the cross-linking step and the carbonization step results in an electrode with improved battery life performance including a lower capacity fade during cycling. Without being bound by theory, it is believed that the cross-linking step allows for the cross-linking of the carbon-containing molecules in the polymeric binder resulting in stabilization of the cross-linked intermediate electrode which undergoes further stabilization during the carbonization step. The methods disclosed herein are especially well-suited to minimizing or preventing coupled electrochemical/mechanical degradation of negative electrodes comprising the silicon-containing electroactive materials and thus for enhancing capacity retention and reducing charge capacity decay to the levels described previously above. Therefore, the inventive electrode materials have certain advantages, like long term cycling stability, high current efficiency, and high rate capabilities. Such long term cycling stability, high current efficiency, and high rate capabilities are particularly advantageous for power battery and start-stop battery use.

### EXAMPLES

### Example 1—Electrode Preparation

1. Preparation of Untreated Electrode

Silicon powder (size 150 nm, obtained from Paraclete Energy) and polyacrylonitrile (PAN) (molecular weight (Mw) of 150,000, obtained from Sigma-Aldrich) were used as the active material and binder, respectively. PAN solution was prepared by dissolving PAN in N-nethy-2-pyrrolidone (NMP) (99.5%, obtained from Alfa Asear). Slurries were then made by mixing Si powder in PAN solution at a weight ratio of 3:2 in a planetary mixer/deaerator (Mazerustar KK-250S, Kurabo). Si/PAN Untreated Electrode 1, Si/PAN Untreated Electrode 2, and Si/PAN Untreated Electrode 3 were prepared by casting the slurries onto a copper foil followed by a drying process which was carried out at 80° C. for 12 hours in a convection oven (Yamato, DKN 812).

2. Cross-Linking (Stabilizing) Process:

A furnace (Type 30400, Thermolyne) was first heated to 350° C. Si/PAN Untreated Electrode 1 and Si/PAN Untreated Electrode 2 were placed in the furnace and held for 5 minutes in the presence of air to obtain Cross-Linked Si/PAN Electrode 1 and Cross-Linked Si/PAN Electrode 2, respectively.

3. Plasma Treatment (Carbonizing Step):

Cross-Linked Si/PAN Electrode 1 and Cross-Linked Si/PAN Electrode 2 were each first introduced into the oxygen-free microwave plasma chamber of a plasma system (Seki Diamond Systems, AX5010, 2.45 GHz) and then subjected to N₂ plasma under conditions as follows: Cross-Linked Si/PAN Electrode 1 was treated at 200 W, 4 Torr for 4 minutes to form Finished Si/PAN Electrode 1; and Cross-Linked Si/PAN Electrode 2 was treated at 400 W, 15 Torr for 10 minutes to form Finished Si/PAN Electrode 2. Si/PAN Untreated Electrode 3 was plasma treated the same way as Cross-Linked Si/PAN Electrode 2 to form Plasma Treated Si/PAN Electrode 3. Tables 1-3 provide further details regarding the prepared electrodes.

TABLE 1

| | | | Electrode Mass | | |
|---|---|---|---|---|---|
| | | Untreated | After Cross- | | |
| | | Electrode Mass | Linking | Electrode | |
| | | (Si/PAN | (Cross-Linked | Mass after | |
| | Electrode | Untreated | Si/PAN | Plasma | Binder Phase |
| Sample | Formulation | Electrode 2) | Electrode 2) | Treatment | Mass Loss |
| Finished | PAN/Si | 19.14 mg | 19.00 mg | 18.86 mg | 37% |
| Si/PAN | (40/60) | | | | |
| Electrode 2 | | | | | |

TABLE 2

| | | | Electrode Mass | | |
|---|---|---|---|---|---|
| | | Untreated | After Cross- | | |
| | | Electrode Mass | Linking | Electrode | |
| | | (Si/PAN | (Cross-Linked | Mass after | |
| | Electrode | Untreated | Si/PAN | Plasma | Binder Phase |
| Sample | Formulation | Electrode 1) | Electrode 1) | Treatment | Mass Loss |
| Finished | PAN/Si | 19.5 mg | 19.26 mg | 19.26 mg | 27% |
| Si/PAN | (40/60) | | | | |
| Electrode 1 | | | | | |

TABLE 3

| | | Untreated | | |
|---|---|---|---|---|
| | | Electrode Mass | Electrode | Binder |
| | | (Si/PAN | Mass after | Phase |
| | Electrode | Untreated | Plasma | Mass |
| Sample | Formulation | Electrode 3) | Treatment | Loss |
| Plasma Treated | PAN/Si | 19.3 mg | 18.62 mg | 83% |
| Si/PAN Electrode 3 | (40/60) | | | |

4. X-Ray Diffraction (XRD) Analysis:

XRD patterns were obtained using the Siemens D5000 X-Ray Diffractometer. The tests were carried out with a 2θ range from 10° to 80° using a Cu Kα radiation. A step scan mode was employed with an increment of 0.02° and a time duration of 1 s for each step operated at 40 kV and 30 mA. The same XRD measurement was performed on Finished Si/PAN Electrode 1, Cross-Linked Si/PAN Electrode 1, and Untreated Si/PAN Electrode 1. The results are shown in FIG. 2. In FIG. 2, x-axis (310) is 2θ, while intensity (a.u.) is shown on the y-axis (320). Copper peaks (330) and silicon peaks (340) for Finished Si/PAN Electrode 1 (350), Cross-Linked Si/PAN Electrode 1 (360), and Untreated Si/PAN Electrode 1 (370) are shown. As shown in FIG. 1, no phase change was observed in silicon (340) after plasma treatment.

### Example 2—Coin Cell Fabrication and Electrochemical Testing

Electrochemical tests were performed on coin-type cells (CR2025) with Si/PAN electrodes prepared as described in Example 1 as positive electrode and a metallic lithium foil (Sigma-Aldrich) as both negative and reference electrode. A microporous polypropylene film (Celgard 3501) was used as a separator. 1M LiPF₆ salt in a 1:1 (w/w) mixture of ethylene carbonate (EC, Gotion) and diethyl carbonate (DEC, Gotion) with 10 wt % fluoroethylene carbonate (FEC, Gotion) additive was used as an electrolyte. The cells were assembled in an argon-filled glove box (MBRAUN).

Cycling tests were carried out using a VMP3 potentiostats (Biologic) with a voltage window of 0.01 to 1.00 V versus Li/Li⁺. The charging/discharging rate was set at C/10 for the first two cycles and C/3 for the subsequent cycles. A theoretical capacity of 3600 mAh/g was used to calculate the C rate.

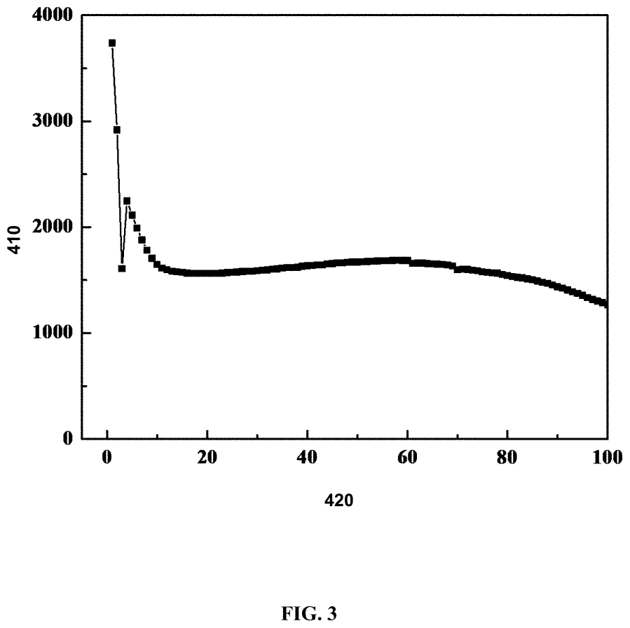

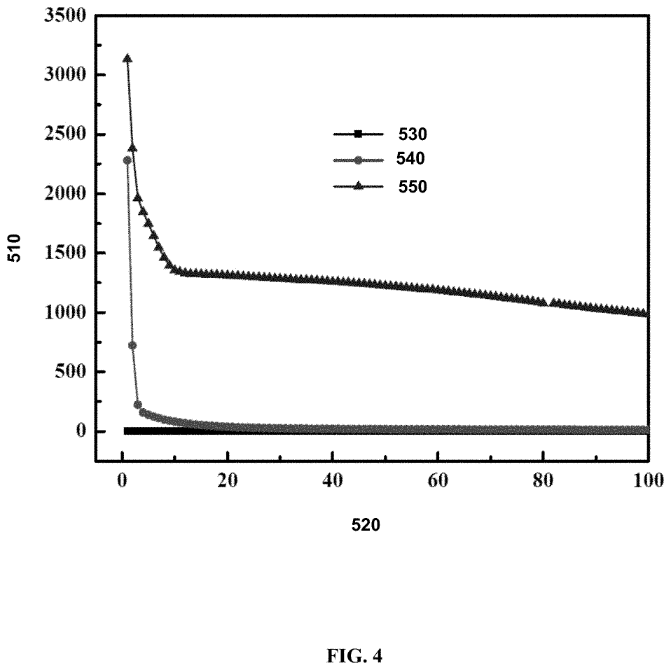

The charging and discharging profiles of the electrochemical performance of a coin cell with Finished Si/PAN Electrode 1 is shown in FIG. 3. In FIG. 3, y-axis specific capacity (410) is in mAh/g units, while cycle number is shown on the x-axis (420). The charging and discharging profiles of the electrochemical performance of coin cells prepared with Untreated Si/PAN Electrode 1 (530), Plasma Treated Electrode 3 (540), and Finished Si/PAN Electrode 2 (550) are shown in FIG. 4. In FIG. 4, y-axis specific capacity (510) is in mAh/g units, while cycle number is shown on the x-axis (520).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making an electrode for an electrochemical cell, the method comprising:
cross-linking a first mixture comprising a polymeric binder and an electroactive material comprising silicon, lithium, graphite, and a combination thereof to form a cross-linked intermediate electrode comprising the electroactive material dispersed within the polymeric binder, wherein at least a portion of the polymeric binder is cross-linked; and
carbonizing the cross-linked intermediate electrode to form the electrode, wherein the carbonizing comprises plasma treating the cross-linked intermediate electrode, exposing the cross-linked intermediate electrode to electromagnetic radiation, or a combination thereof.

2. The method of claim 1, wherein the cross-linking comprises heating the first mixture to a temperature of greater than or equal to about 100° C. in the presence of an inert gas, a reactive gas, or a combination thereof.

3. The method of claim 1, wherein the cross-linking comprises admixing a cross-linking agent with the first mixture to form the cross-linked intermediate electrode.

4. The method of claim 3, wherein the cross-linking agent comprises at least one reactive group selected from the group consisting of an amino group, an isocyanate group, a carboxyl group, a hydroxyl group, an anhydride group, an epoxide group, and a combination thereof.

5. The method of claim 1, wherein the polymeric binder is selected from the group consisting of poly(ether imide) (PEI), polyacrylic acid (PAA), poly(amic acid), polysulfone (PSF), polyphenylsulfone (PPSF), polyethersulfone (PESF), polyamide, polyvinylidene fluoride (PVDF), polyacrylonitrile (PAN), a polyolefin, cellulose, derivatives of cellulose, cellulose acetate, pitch, lignin, polyalkylene oxide (PAO), polyvinylidene difluoride (PVDF), polymethylmethacrylate (PMMA), polyimide (PI), copolymers, and combinations thereof.

6. The method of claim 1, wherein the plasma originates from a gas comprising oxygen, air, ammonium, hydrogen, nitrogen, helium, argon, neon, and a combination thereof.

7. The method of claim 1, wherein the plasma is generated by an alternating current, a direct current, a radio wave, or a microwave radiation.

8. The method of claim 1, wherein the carbonizing comprises exposing the cross-linked intermediate electrode to electromagnetic radiation having a frequency between about 3 kHz and about 300 GHz.

9. The method of claim 1, wherein the first mixture comprises a weight ratio of electroactive material to polymeric binder of about 50:1 to about 1:10.

10. The method of claim 1, wherein the electrode comprises an amount of a binder phase not less than about 30% by mass of the polymeric binder present in the first mixture.

11. The method of claim 1, wherein the first mixture further comprises electrically conductive particles.

12. The method of claim 11, wherein the electrically conductive particles are selected from the group consisting of carbon black, graphite, carbon nanotubes, carbon fibers, graphene, graphene oxide, metallic powder, a liquid metal and combinations thereof.

13. The method of claim 1, further comprising one or more of:
(i) admixing a solvent with the polymeric binder and the electroactive material to form the first mixture, wherein the solvent is selected from the group consisting of: water, methanol, acetone, ethanol, N-methyl-2-pyrrolidone (NMP), dimethylformamide (DMF), and combinations thereof;
(ii) applying the first mixture to a current collector and volatilizing the first mixture to form an untreated electrode; and
(iii) pressing the untreated electrode.

14. A method of making an electrode for an electrochemical cell, the method comprising:
admixing a polymeric binder, an electrically conductive particle, a solvent, and an electroactive material comprising silicon, lithium, graphite, and a combination thereof to form a first mixture;
a cross-linking step comprising:
(i) applying the first mixture to a current collector, volatilizing the solvent to form an untreated electrode and heating the untreated electrode to form a cross-linked intermediate electrode comprising the electroactive material and the electrically conductive particle dispersed within the polymeric binder, wherein at least a portion of the polymeric binder is cross-linked; or
(ii) admixing a cross-linking agent with the first mixture, applying the first mixture to a current collector, and volatilizing the solvent to form the cross-linked intermediate electrode; and
carbonizing the cross-linked intermediate electrode to form the electrode, wherein the carbonizing comprises plasma treating the cross-linked intermediate electrode, exposing the cross-linked intermediate electrode to electromagnetic radiation, or a combination thereof.

15. The method of claim 14, wherein:
(i) the cross-linking comprises heating the first mixture to a temperature of greater than or equal to about 100° C. in the presence of an inert gas, a reactive gas, or a combination thereof; or
(ii) wherein the cross-linking agent comprises a reactive group selected from the group consisting of an amino group, an isocyanate group, a carboxyl group, a hydroxyl group, an anhydride group, an epoxide group, and a combination thereof.

16. The method of claim 14, wherein the polymeric binder is selected from the group consisting of poly(ether imide) (PEI), polyacrylic acid (PAA), poly(amic acid), polysulfone (PSF), polyphenylsulfone (PPSF), polyethersulfone (PESF), polyamide, polyvinylidene fluoride (PVDF), polyacrylonitrile (PAN), a polyolefin, cellulose, derivatives of cellulose, cellulose acetate, pitch, lignin, polyalkylene oxide (PAO), polyvinylidene difluoride (PVDF), polymethylmethacrylate (PMMA), polyimide (PI), copolymers, and combinations thereof; the electrically conductive particles are selected from the group consisting of carbon black, graphite, carbon nanotubes, carbon fibers, graphene, graphene oxide, metallic powder, a liquid metal, and combinations thereof; and the solvent is selected from the group consisting of water, methanol, acetone, ethanol, N-methyl-2-pyrrolidone (NMP), dimethylformamide (DMF), and combinations thereof.

17. The method of claim 14, wherein the plasma originates from a gas comprising oxygen, air, ammonium, hydrogen, nitrogen, helium, argon, neon, and a combination thereof, and wherein the plasma is generated by an alternating current, a direct current, a radio wave, or a microwave.

18. The method of claim 14, wherein the carbonizing comprises exposing the cross-linked intermediate electrode to electromagnetic radiation having a frequency between about 3 kHz and about 300 GHz.

19. The method of claim 14, wherein the electrode comprises an amount of a binder phase not less than about 30% by mass of the polymeric binder present in the first mixture.
